(19) United States
(12) Patent Application Publication
(10) Pub. No.: US 2026/0319298 A1
(43) Pub. Date: Oct. 15, 2026

(54) MANUFACTURING METHOD OF LIQUID CRYSTAL ELEMENT, LIQUID CRYSTAL ELEMENT

(71) Applicant: STANLEY ELECTRIC CO., LTD., Tokyo (JP)

(72) Inventors: Yasuo TOKO, Tokyo (JP); Satomi SUZUKI, Tokyo (JP)

(73) Assignee: STANLEY ELECTRIC CO., LTD., Tokyo (JP)

(21) Appl. No.: 19/467,844

(22) Filed: Feb. 3, 2026

(30) Foreign Application Priority Data
Feb. 6, 2025 (JP) 2025-018488

(51) Int. Cl. G02F 1/1337

(52) U.S. Cl. CPC G02F 1/133788; G02F 1/133711; G02F 1/133746

(57) ABSTRACT

A manufacturing method of a liquid crystal element having a liquid crystal layer disposed between a pair of substrates, the method including: (a) preparing a first substrate and a second substrate, each having a transparent electrode on its one surface side; (b) forming a liquid crystal layer between one surface of the first substrate and one surface of the second substrates using a liquid crystal material containing a polymerizable molecule; and (c) forming a polymer layer on the one surface side of each of the first substrate and the second substrate by performing light irradiation to the liquid crystal layer through the first substrate or the second substrate; where the above description (c) includes performing a first light irradiation to the entire liquid crystal layer from a direction oblique with respect to an other surface that faces the one surface of the first substrate or the second substrate.

### BACKGROUND

### Technical Field

The present disclosure relates to a manufacturing method of a liquid crystal element, and a liquid crystal element.

### Description of the Background Art

Japanese Unexamined Patent Application Publication No. 2019-128383 discloses a liquid crystal display device having a pair of substrates, a liquid crystal layer between the pair of substrates, and an alignment film provided at a surface facing the liquid crystal layer of at least one of the pair of substrates. The liquid crystal display device further includes a polymer layer between the liquid crystal layer and the alignment film, the liquid crystal layer contains a liquid crystal compound that is aligned in a predetermined direction when no voltage is applied, the alignment film contains a first polymer having at least a polyamic acid structure or a polyimide structure in its main chain, the first polymer having a functional group that functions as a polymerization initiator, and the polymer layer contains a second polymer obtained by polymerizing at least one type of monomer having a chalcone group.

In the liquid crystal display device described above, a polymer layer capable of horizontally aligning a liquid crystal compound can be formed by irradiation with polarized ultraviolet light.

However, there is room for improvement in that the alignment film that can be used is limited to one containing a first polymer having at least a polyamic acid structure or a polyimide structure in its main chain.

In a specific aspect, it is an object of the present disclosure to provide a technique for manufacturing a liquid crystal element that can realize alignment treatment of a liquid crystal layer through a simple process. Further, in a specific aspect, it is an object of the present disclosure to provide a liquid crystal element obtained by the above process.

### Summary

(1) A manufacturing method of a liquid crystal element according to one aspect of the present disclosure is a method having a liquid crystal layer disposed between a pair of substrates, the method including:
   (a) preparing a first substrate and a second substrate, each having a transparent electrode on its one surface side;
   (b) forming a liquid crystal layer between one surface of the first substrate and one surface of the second substrates using a liquid crystal material containing a polymerizable molecule;
   (c) forming a polymer layer on the one surface side of each of the first substrate and the second substrate by performing light irradiation to the liquid crystal layer through the first substrate or the second substrate;
   where the above description (c) includes performing a first light irradiation to the entire liquid crystal layer from a direction oblique with respect to an other surface that faces the one surface of the first substrate or the second substrate.
(2) A liquid crystal element according to one aspect of the present disclosure is a liquid crystal element including:
   a first substrate and a second substrate arranged with one surface side of each substrate facing each other;
   a liquid crystal layer arranged between one surface of the first substrate and one surface of the second substrates; and
   a polymer layer arranged between the first substrate and the liquid crystal layer, and between the second substrate and the liquid crystal layer;
   where the polymer layer contains a plurality of polymers having a major axis in a direction oblique to one surface of the first substrate and one surface of the second substrate; and
   where, when a voltage is applied, the liquid crystal layer forms at least two domains configured corresponding to the direction of the major axis of each of the plurality of polymers contained in the polymer layer.

According to the above configuration, it is possible to provide a technique for manufacturing a liquid crystal element that can realize alignment treatment of a liquid crystal layer through a simple process. Further, it is possible to provide a liquid crystal element obtained by the above process.

### BRIEF DESCRIPTION OF THE DRAWINGS

FIG. 1 is a schematic cross-sectional view showing the configuration of a liquid crystal element according to the first embodiment.

FIG. 2A to FIG. 2D are diagrams for explaining the manufacturing method of the liquid crystal element according to the first embodiment.

FIG. 3 is a diagram for explaining the manufacturing method of the liquid crystal element according to the first embodiment.

FIG. 4 is a diagram illustrating a measurement example of the relationship between the tilt angle θ and the pretilt angle.

FIG. 5A to FIG. 5D are diagrams illustrating an exemplary structures of the RM agents.

FIG. 6A and FIG. 6B are diagrams for explaining the light irradiation process in the manufacturing method of a liquid crystal element according to the second embodiment.

FIG. 7 is a diagram illustrating a measurement example of the relationship between the voltage applied to the liquid crystal element and the pretilt angle imparted to the liquid crystal layer during the second light irradiation.

FIG. 8A and FIG. 8B are diagrams for explaining the light irradiation process in the manufacturing method of a liquid crystal element according to the third embodiment.

FIG. 9 is an enlarged view (photograph) of the boundary portion between the domains of the liquid crystal element manufactured by the manufacturing method of the third embodiment.

FIG. 10A and FIG. 10B are diagrams for explaining the light irradiation process in the manufacturing method of a liquid crystal element according to the fourth embodiment.

FIG. 11 is an enlarged view (photograph) of the boundary portion between the domains of the liquid crystal element manufactured by the manufacturing method of the fourth embodiment.

FIG. 12A and FIG. 12B are diagrams for explaining the light irradiation process in the manufacturing method of a liquid crystal element according to the sixth embodiment.

FIG. 13 is a schematic planer view illustrating a configuration example of a liquid crystal element manufactured by applying the manufacturing method according to the sixth embodiment.

FIG. 14 is a schematic view showing a configuration example of a liquid crystal element according to the seventh embodiment.

FIG. 15 is a schematic diagram illustrating an exemplary structures of a jig used in the manufacturing process of a liquid crystal element according to the eighth embodiment.

FIG. 16A to FIG. 16D are diagrams for explaining the structure of the polymer layer.

FIG. 17A shows a measurement example for determining the azimuth angle direction of the easy axis (easy axis of alignment) of the liquid crystal layer.

FIG. 17B and FIG. 17C are diagrams for explaining the relationship between the direction of each light irradiation and the azimuth angle direction of the easy axis.

### DESCRIPTION OF THE PREFERRED EMBODIMENTS

### First Embodiment

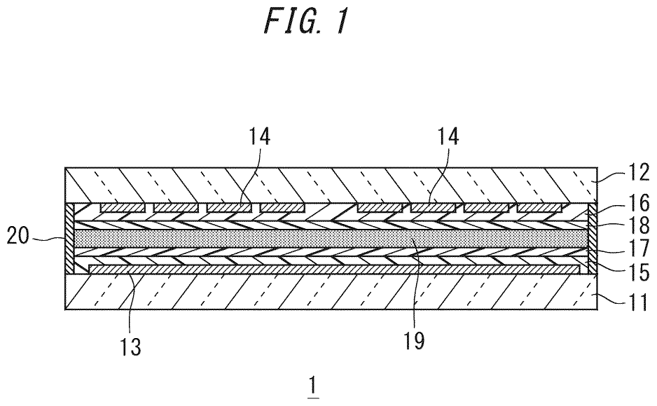

FIG. 1 is a schematic cross-sectional view showing the configuration of a liquid crystal element according to the first embodiment. The liquid crystal element 1 is configured to include a pair of opposing substrates: a first substrate 11 and a second substrate 12, a common electrode 13, a plurality of pixel electrodes (counter electrodes) 14, alignment films 15 and 16, polymer layers (polymerized films) 17 and 18, a liquid crystal layer 19, and a sealing material 20.

First substrate 11 and second substrate 12 are each rectangular in a planer view, and are arranged opposite each other. Each substrate can be a transparent substrate, such as a glass substrate or a plastic substrate. Spherical spacers (not shown) made of a resin film are dispersed between first substrate 11 and second substrate 12, and these spherical spacers maintain a gap between the substrates at a desired size (for example, approximately several μm). Here, instead of spherical spacers, pillars made of resin or the like may be provided on first substrate 11 side or second substrate 12 side and may be used as spacers.

Common electrode 13 is provided on the side of first substrate 11 facing second substrate 12. Common electrode 13 is formed by appropriately patterning a transparent conductive film, such as indium tin oxide (ITO).

Each pixel electrode 14 is provided on the side of second substrate 12 facing first substrate 11. These pixel electrodes 14 are formed by appropriately patterning a transparent conductive film such as indium tin oxide (ITO). A pixel section is formed at each of the opposing portions of each pixel electrode 14 and common electrode 13.

Alignment film (first alignment film) 15 is provided on one surface side of first substrate 11, covering common electrode 13. Similarly, alignment film (second alignment film) 16 is provided on one surface side of second substrate 12, covering each pixel electrode 14. As each of alignment films 15 and 16, for example, a vertical alignment film that regulates the alignment state of liquid crystal layer 19 to a substantially vertical alignment is used. Uniaxial alignment treatment such as rubbing treatment is not performed on each alignment film 15, 16.

Polymer layer 17 is disposed on the surface of alignment film 15 facing liquid crystal layer 19 so as to be in contact with liquid crystal layer 19. Polymer layer 18 is disposed on the surface of alignment film 16 facing liquid crystal layer 19 so as to be in contact with liquid crystal layer 19.

Liquid crystal layer 19 is disposed between first substrate 11 and second substrate 12. In the present embodiment, liquid crystal layer 19 is configured using a fluid nematic liquid crystal material with a negative dielectric anisotropy Δε. Liquid crystal layer 19 of the present embodiment is configured so that when no voltage is applied, the alignment direction of the liquid crystal molecules is tilted in one direction, resulting in a substantially perpendicular alignment with respect to the surfaces of the substrates, with a pretilt angle in the range of 85° or more and less than 90°, for example.

Sealing material 20 is used to seal liquid crystal layer 19 and is arranged between first substrate 11 and second substrate 12, surrounding liquid crystal layer 19. Sealing material 20 is arranged in a ring shape between first substrate 11 and second substrate 12. Sealing material 20 has an injection opening (not shown) formed by opening a portion thereof. The injection port is used to inject liquid crystal material between first substrate 11 and second substrate 12 during the manufacture of liquid crystal element 1. The injection port is sealed with an end seal material.

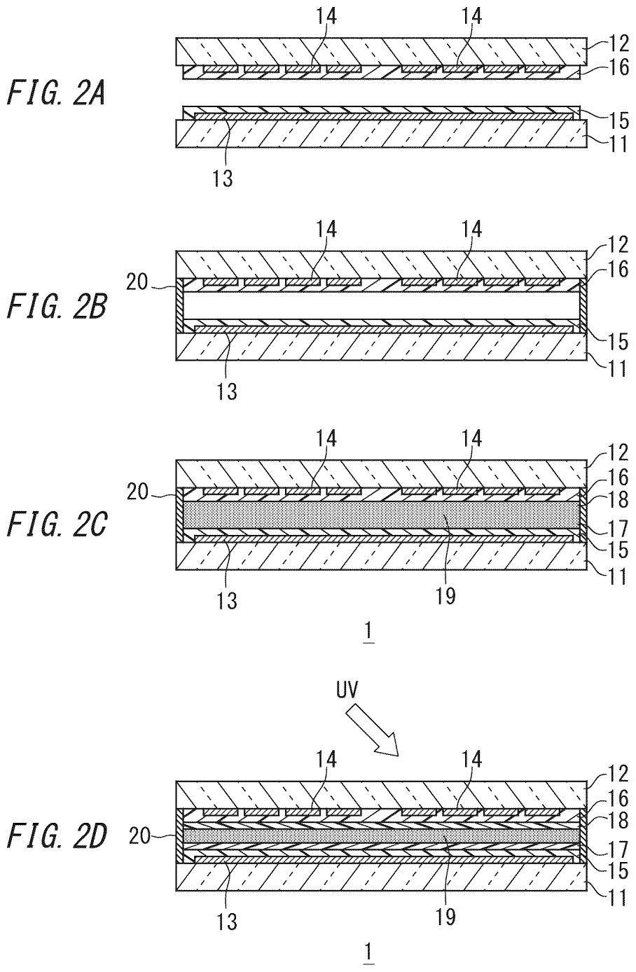

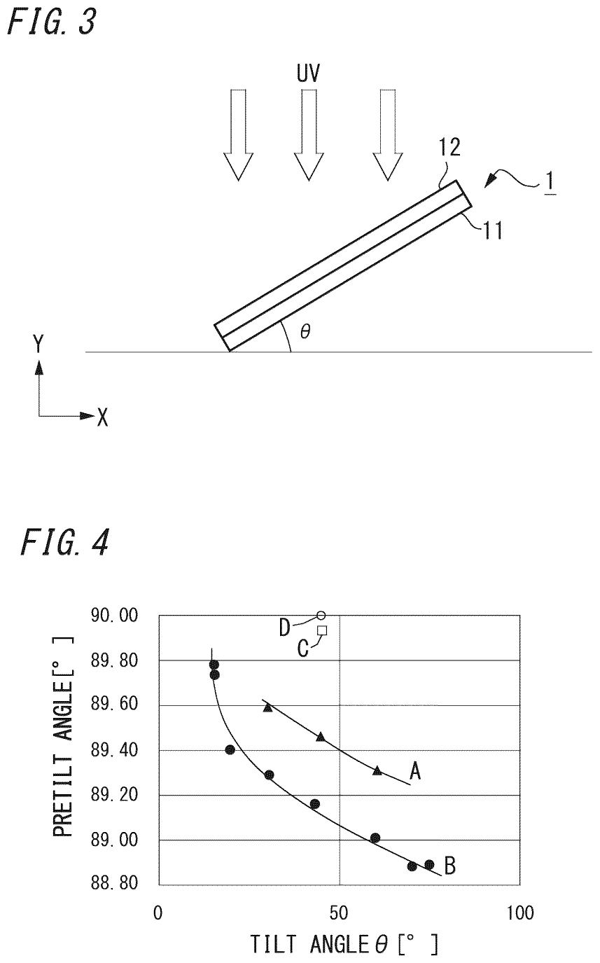

FIG. 2A to FIG. 2D and FIG. 3 are diagrams for explaining the manufacturing method of the liquid crystal element according to the first embodiment. Here, note that the order of each process can be reversed or performed in parallel as long as no contradictions or inconsistencies arise, and other processes not shown or described (such as cleaning process) can be added as appropriate.

First, first substrate 11 having common electrode 13 is prepared, and second substrate 12 having pixel electrodes 14 is prepared. Common electrode 13 and pixel electrodes 14 are obtained by patterning an ITO film formed on one surface of each of first substrate 11 and second substrate 12, using photolithography or other techniques.

Alignment film 15 is formed on one surface of first substrate 11, covering common electrode 13 (FIG. 2A). Similarly, alignment film 16 is formed on one surface of second substrate 12, covering each pixel electrode 14 (FIG. 2A). Each alignment film 15, 16 is formed by applying a vertical alignment film material and baking it under specified conditions. In the present embodiment, no alignment treatment such as rubbing treatment is performed on each alignment film 15, 16.

Next, sealing material 20 made of a photocurable resin or the like is applied to one side of first substrate 11 or second substrate 12, and spherical spacers for gap control are dispersed on one side of the substrate (first substrate 11 in this embodiment) which is not applied with sealing material 20. Then, after bonding first substrate 11 and second substrate 12 together, sealing material 20 is cured by light irradiation or the like (FIG. 2B). A predetermined gap is created between first substrate 11 and second substrate 12 by the spherical spacers or the like.

Next, a liquid crystal material is injected into the gap between first substrate 11 and second substrate 12 by vacuum injection through an injection port (a portion where part of sealing material 20 is opened) (not shown), thereby forming liquid crystal layer 19 (FIG. 2C). In the present embodiment, a liquid crystal material including reactive mesogen agent (RM agent), i.e., a monomer that can be polymerized (polymerizable molecule) by light (particularly ultraviolet light), is used. For example, it is preferable to add 0.3 wt % or more of RM agent to the liquid crystal material.

Here, One Drop Fill method (ODF method) may also be used when injecting the liquid crystal material. In this case, after forming sealing material 20 and before bonding first substrate 11 and second substrate 12 together, the liquid crystal material is dropped (disposed) within the area surrounded by sealing material 20, and then first substrate 11 and second substrate 12 may be bonded together.

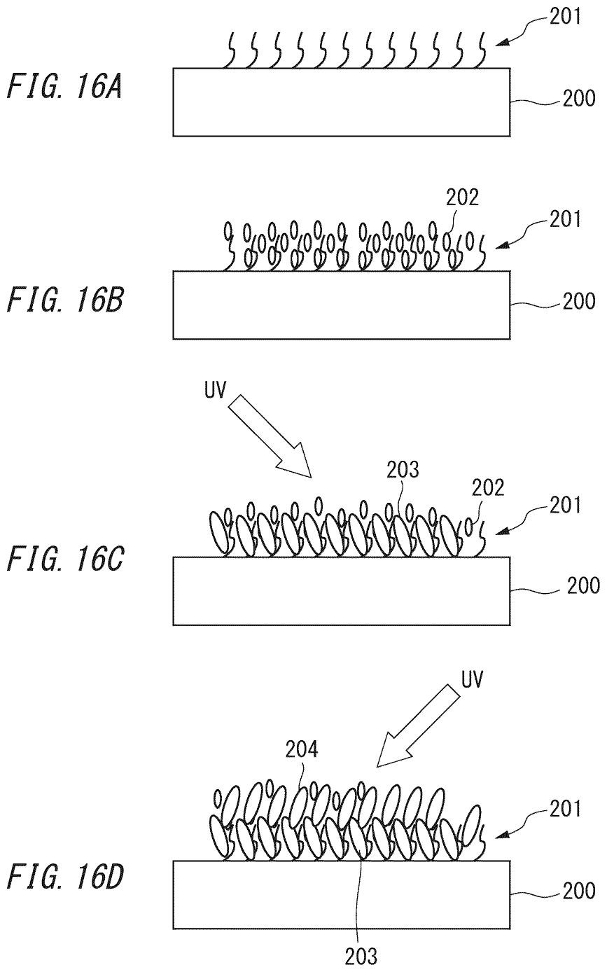

Next, light is irradiated onto liquid crystal layer 19 from the outer side surface (the other surface opposite to the one surface) of first substrate 11 or second substrate 12, through first substrate 11 or second substrate 12. This causes the monomers contained in liquid crystal layer 19 to polymerize, forming a polymer layer 17 on the first substrate 11 side and a polymer layer 18 on the second substrate 12 side (FIG. 2D). Each polymer layer 17, 18 is considered to contain a polymer or monomer with its major axis in a direction oblique to the respective one surfaces of first substrate 11 and second substrate 12 (refer to FIG. 16B to FIG. 16D, to be described later). These polymer layers 17 and 18 provide an alignment regulating force to liquid crystal layer 19, such that liquid crystal layer 19 is uniformly aligned. Liquid crystal element 1 is thus completed.

As shown in a simplified form in FIG. 3, in the present embodiment, ultraviolet light (UV light) is irradiated from a relatively oblique direction onto the substrate surface of liquid crystal element 1, i.e., the outer side surface of first substrate 11 (or second substrate 12). For example, liquid crystal element 1 is tilted by an angle θ with respect to the X axis shown in the figure, and ultraviolet light is irradiated from a direction along the Y axis, which is perpendicular to the X axis. The tilt angle θ can be set at any angle up to 90°, and for example, can be set at or around 45°. Further, irradiation time of the ultraviolet light can also be set arbitrarily. This tilt angle θ can also be said to be the angle between the substrate surface of liquid crystal element 1 and the irradiation direction of the ultraviolet light.

Here, when a photocurable substance (such as resin) is used as sealing material 20, sealing material 20 can be cured simultaneously during the process of forming polymer layers 17 and 18. In such a case, the light irradiation process shown in FIG. 2B can be omitted. That is, there is no need to add a new process for forming polymer layer 17 and polymer layer 18; this can be combined with the process of curing sealing material 20, thereby simplifying the manufacturing method. Here, note that while the use of a photocurable resin as the sealing material has been described, a thermosetting resin may also be used.

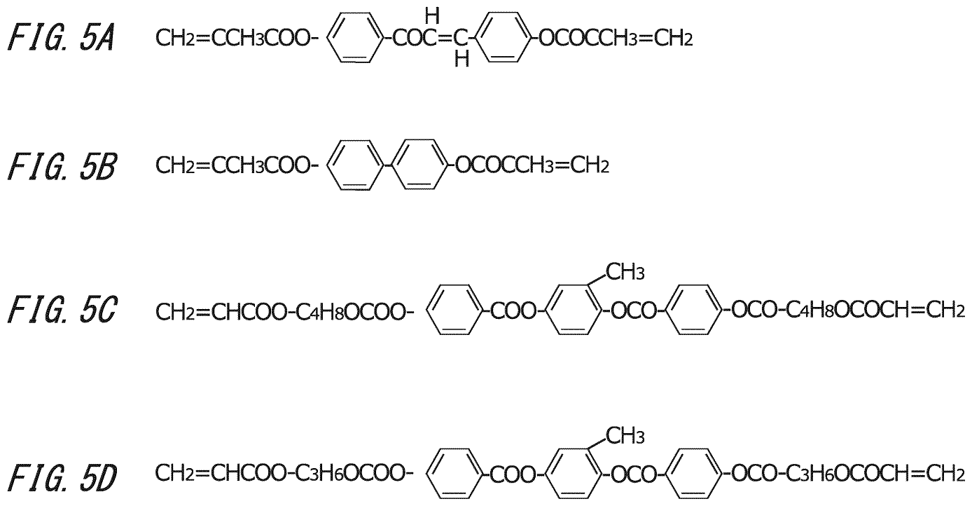

FIG. 4 is a diagram illustrating a measurement example of the relationship between the tilt angle θ and the pretilt angle. Here, liquid crystal element 1 was fabricated by adding 0.5 wt % of each RM agent having the structure shown in FIG. 5A to FIG. 5D to the liquid crystal material. The tilt angle θ of liquid crystal element 1 when irradiated with ultraviolet light was changed in order to determine the pretilt angle at each setting. The liquid crystal layer thickness was set to 4 μm, a typical vertical alignment film was used as the alignment film, the ultraviolet light irradiation condition was set to 10 mW/cm² and light irradiation was performed for 10 minutes. The symbol “A” in FIG. 4 indicates the characteristics of a liquid crystal element using the RM agent shown in FIG. 5A. The other symbols “B”, “C”, and “D” similarly indicate the characteristics of liquid crystal elements using the RM agents shown in FIG. 5B, FIG. 5C, and FIG. 5D, respectively. The RM agent shown in FIG. 5A is 2-Methyl-acrylic acid 4-{3-[4-(2-methyl-acryloyloxy)-phenyl]-3-oxo-propenyl}-phenyl ester, and the RM agent shown in FIG. 5B is 4, 4′-Bis (methacryloyloxy) biphenyl. Further, the RM agent shown in FIG. 5C is 2-Methyl-1, 4-phenylene Bis [4-[[[4-(acryloyloxy)butoxy],carbonyl]oxy]benzoate], and the RM agent shown in FIG. 5D is 1, 4-Bis [4-(3-acryloyloxypropoxy) benzoyloxy]-2-methylbenzene. All of these RM agents have acrylate or methacrylate at both ends of their skeletons, which are polymerizable groups.

In liquid crystal elements 1 using the RM agent with the structure shown in FIG. 5A and FIG. 5B, there was a tendency for the pretilt angle to decrease as the tilt angle θ increased, as shown in FIG. 4. In other words, it was found that the pretilt angle can be controlled by changing the tilt angle θ. Further, the alignment state of liquid crystal layer 19 in liquid crystal element 1 using these RM agents was extremely favorable and a uniform alignment state was obtained. On the other hand, in liquid crystal element 1 using the RM agent with the structure shown in FIGS. 5C and 5D, almost no pretilt angle was imparted.

Based on these results, when comparing RM agents whose alignment are controllable with those whose alignment are not controllable, differences can be seen in the skeleton of their molecular structures. Specifically, RM agents whose alignment is controllable each has two ring structures located in the central part of the skeleton, that is, the location between the polymerizable groups on both ends, and is considered to be relatively rigid. On the contrary, the RM agents whose alignment is difficult to control each has three ring structures, and is considered to be connected by a soft portion (ester bond) and located in the central part of the skeleton, which is easily bent.

In detail, when the RM agent is irradiated with light and polymerizes due to the direction of the ultraviolet light, it polymerizes in a manner that corresponds to the anisotropy with respect to the direction of the ultraviolet light. Here, if the central part of the skeleton is rigid, it is considered that when the acrylate on one side polymerizes, the polymerization proceeds without the molecules bending at the central part of the skeleton. On the contrary, if the central part of the skeleton is flexible, it is considered that when the acrylate on one side polymerizes, even when the polymerized shape is uniform on one side, since the central part of the skeleton bends, as a whole, polymerization proceeds in a manner that is closer to random. Therefore, it is considered that RM agents whose central part of the skeleton is rigid are preferred, and that the central part of the skeleton preferably contains two or fewer cyclic structures. Specifically, as a RM agent, biphenyls such as biphenyl diacrylate and biphenyl dimethacrylate can be suitably used.

Here, in the light irradiation process for liquid crystal element 1 (refer to FIG. 2D), it is also preferable to perform light irradiation a plurality of times while varying the relative irradiation direction of the ultraviolet light. Such light irradiation process will be described in detail below. Here, the manufacturing process prior to the light irradiation is the same as in the first embodiment described above, therefore its description will be omitted.

### Second Embodiment

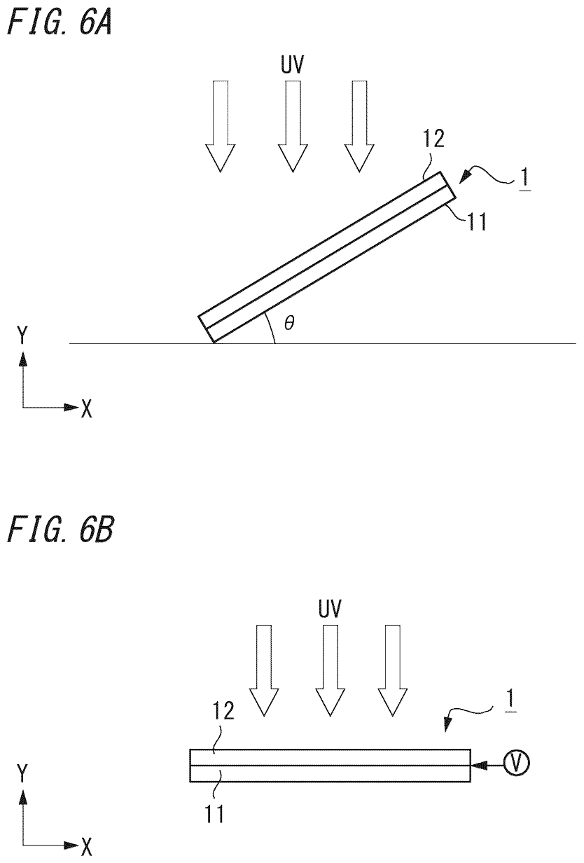

FIG. 6A and FIG. 6B are diagrams for explaining the light irradiation process in the manufacturing method of a liquid crystal element according to the second embodiment. As shown in FIG. 6A, during the first light irradiation, similar to the light irradiation process according to the first embodiment described above, ultraviolet light is irradiated from a relatively oblique direction relative to the substrate surface of liquid crystal element 1. For example, liquid crystal element 1 is tilted by tilt angle θ with respect to the X axis shown in the figure, and ultraviolet light is irradiated from a direction along the Y axis, which is perpendicular to the X axis.

As shown in FIG. 6B, during the second light irradiation, ultraviolet light is irradiated with liquid crystal element 1 at tilt angle θ of 0°. That is, ultraviolet light is irradiated from the normal direction to the substrate surface of liquid crystal element 1. At this time, a voltage is applied to liquid crystal layer 19 of liquid crystal element 1 using common electrode 13 and each pixel electrode 14. By applying a voltage to liquid crystal layer 19 in this way during the second light irradiation process, pretilt angle can be controlled according to the magnitude of the voltage. Specifically, the higher the voltage, the smaller the pretilt angle.

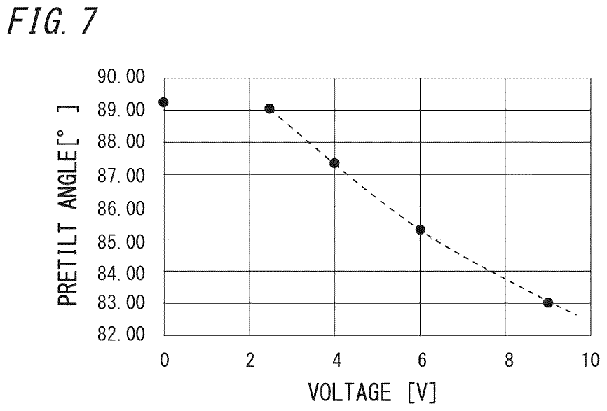

FIG. 7 is a diagram illustrating a measurement example of the relationship between the voltage applied to the liquid crystal element and the pretilt angle imparted to the liquid crystal layer during the second light irradiation. Here, pretilt angle was measured using liquid crystal element 1 which was manufactured using the RM agent shown in FIG. 5A described above. Specifically, liquid crystal element 1 was fabricated by adding 0.5 wt % of the RM agent shown in FIG. 5A to the liquid crystal material. The liquid crystal layer thickness was set to 4μm, and a typical vertical alignment film was used as the alignment film. The tilt angle θ during the first light irradiation was set to 45°, and the tilt angle θ during the second light irradiation was set to 0°. The ultraviolet light irradiation intensity for each irradiation was set to 10 mW/cm², the first light irradiation was performed for 5 minutes, and the second light irradiation was performed for 10 minutes. The voltage applied to liquid crystal layer 19 during the second light irradiation was variably set to 2.5V, 4V, 6V, and 9V.

As shown in FIG. 7, it can bee seen that the pretilt angle decreases as the voltage applied to liquid crystal layer 19 increases. Specifically, when the voltage is 2.5V, the pretilt angle is 89.0°, and as the voltage changes to 4V, 6V, and 9V, the pretilt angle changes to 87.4°, 85.3°, and 83.0°. That is, by changing the voltage applied to liquid crystal layer 19 during the second light irradiation, the pretilt angle imparted to liquid crystal layer 19 can be variably set. Since the pretilt angle can be variably set in this way, for example, when a liquid crystal element for high-duty driving application is desired, a high pretilt angle can be imparted by setting the applied voltage low. Conversely, when a liquid crystal element for low-duty driving application is desired, a low pretilt angle can be imparted by increasing the applied voltage.

### Third Embodiment

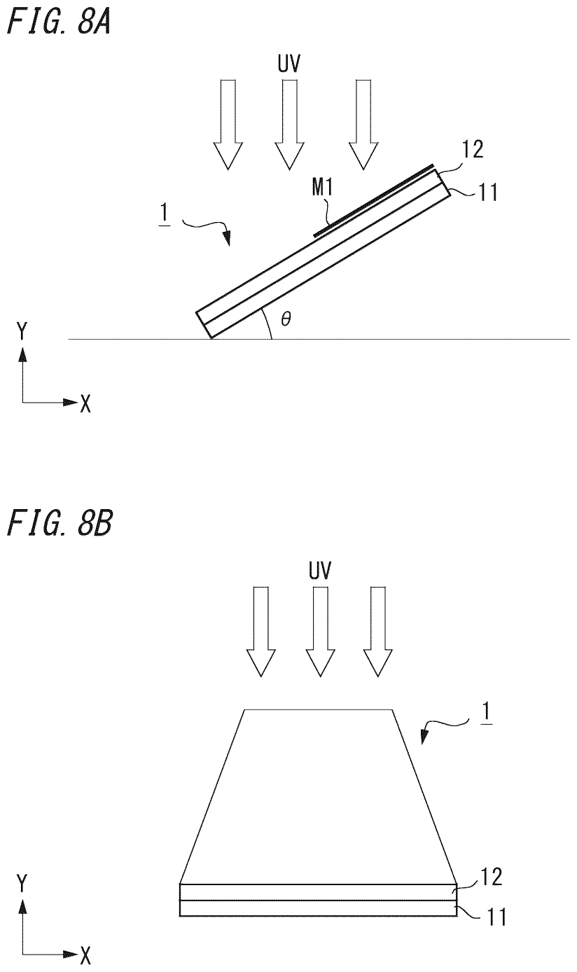

FIG. 8A and FIG. 8B are diagrams for explaining the light irradiation process in the manufacturing method of a liquid crystal element according to the third embodiment. As shown in FIG. 8A, during the first light irradiation, similar to the light irradiation process according to the first embodiment described above, ultraviolet light is irradiated from an oblique direction relative to the substrate surface of liquid crystal element 1. For example, liquid crystal element 1 is tilted by tilt angle θ relative to the X axis shown in the figure, and ultraviolet light is irradiated from a direction along the Y axis perpendicular to the X axis. At this time, light irradiation is performed while a light-shielding mask M1 is placed on the substrate surface (the surface on the light incident side) of liquid crystal element 1, covering a part of the substrate surface. The portion of the substrate surface to be covered can be arbitrarily determined. FIG. 8A illustrates a light-shielding mask M1 that covers approximately half of the substrate surface. By using this light-shielding mask M1, light irradiation can be performed in a state where light is not incident on a part of liquid crystal layer 19.

As shown in FIG. 8B, when initiating the second light irradiation, liquid crystal element 1 is rotated in an azimuth angle direction from the first light irradiation, and light irradiation is performed to the entire substrate surface of liquid crystal element 1 without using a light-shielding mask. That is, light irradiation is performed to the entire liquid crystal layer 19. The illustrated example illustrates a case where liquid crystal element 1 is rotated 90° in the azimuth angle direction. Here, note that this rotation angle can be set arbitrarily, for example, 45°. In this way, by rotating liquid crystal element 1 in the azimuth angle direction during the second light irradiation, it is possible to provide two domains with different alignment directions in liquid crystal layer 19. Specifically, the alignment direction can be made different between the portion shielded by light-shielding mask M1 during the first light irradiation and the portion not shielded by light-shielding mask M1.

Here, while the first light irradiation was performed using a partial exposure using a light-shielding mask, and the second light irradiation was performed using a full-surface exposure, these orders may be reversed. In either case, there is an advantage in that multiple light-shielding masks are not used, thereby eliminating the need for highly accurate alignment between the light-shielding masks.

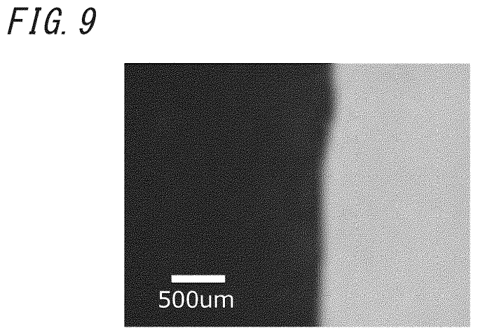

FIG. 9 is an enlarged view (photograph) of the boundary portion between the domains of the liquid crystal element manufactured by the manufacturing method of the third embodiment. Here, liquid crystal element 1 was manufactured by adding 0.5 wt % of the RM agent shown in FIG. 5A to the liquid crystal material. The liquid crystal layer thickness was set to 4 μm, and a typical vertical alignment film was used as the alignment film. The tilt angle θ during the first and second light irradiation was set to 45°. The rotation angle in the azimuth angle direction from the first light irradiation to the second light irradiation was set to 90°. The ultraviolet light irradiation intensity for each irradiation was set to 10 mW/cm², the first light irradiation was performed for 10 minutes, and the second light irradiation was performed for 2 minutes. No voltage has been applied to liquid crystal layer 19.

As shown in the photograph, it can be seen that when a voltage is applied to liquid crystal layer 19, two domains with different alignment directions (directors) are obtained. It can be seen that there are no disclination lines or the like at the boundary between the domains, and that the boundary is clear. Here, in the photograph, the boundary appears to be partially wavy, which reflects the shape of the light-shielding mask M1.

### Fourth Embodiment

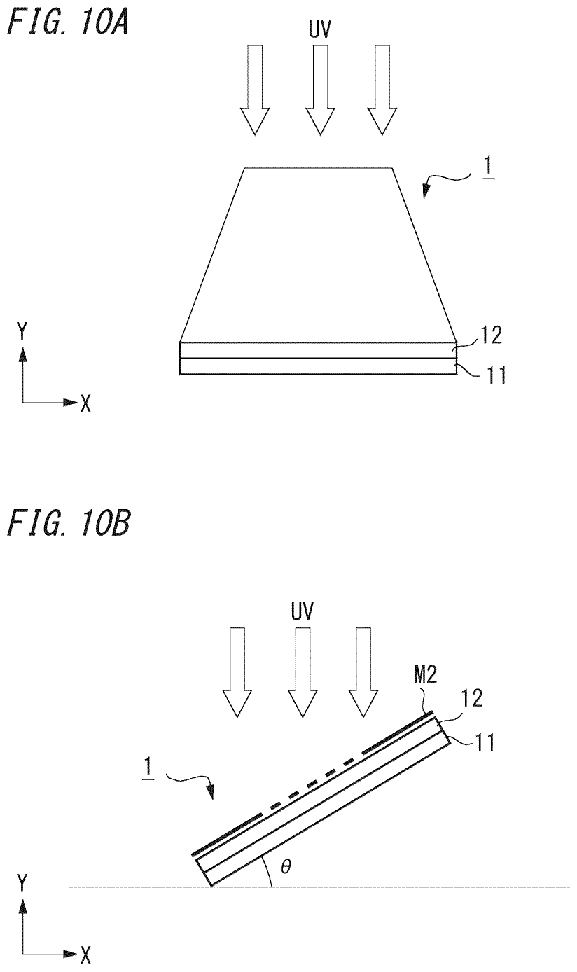

FIG. 10A and FIG. 10B are diagrams for explaining the light irradiation process in the manufacturing method of a liquid crystal element according to the fourth embodiment. As shown in FIG. 10A, during the first light irradiation, similar to the light irradiation process according to the first embodiment described above, ultraviolet light is irradiated from a oblique direction relative to the substrate surface of liquid crystal element 1. For example, liquid crystal element 1 is tilted by tilt angle θ relative to the X axis shown in the figure, and ultraviolet light is irradiated from a direction along the Y axis perpendicular to the X axis.

As shown in FIG. 8B, when initiating the second light irradiation, liquid crystal element 1 is rotated in the azimuth angle direction from the first light irradiation, and light irradiation is performed while a light-shielding mask M2 having a fine light-shielding pattern is placed on the substrate surface of liquid crystal element 1 (the surface on the side where light is incident). That is, light irradiation is performed in a state where the light is not incident on a part of liquid crystal layer 19. The illustrated example illustrates a case where liquid crystal element 1 is rotated 90° in the azimuth angle direction. Here, note that the rotation angle can be set arbitrarily, for example, 45°. In this way, by rotating liquid crystal element 1 in the azimuth angle direction during the second light irradiation, it is possible to arrange a large number of domains with different alignment directions (directors) in liquid crystal layer 19.

Specifically, the alignment direction (director) can be made different between the portion shielded by the fine light-shielding pattern of light-shielding mask M2 during the second light irradiation and the portion not shielded by light-shielding mask M2. The size of the light-shielding pattern is arbitrary, and it can be a light-shielding pattern having multiple light-shielding sections with lengths and widths of several hundred microns, for example. It is preferable that the length and width of each light-shielding section in the light-shielding pattern be 100 microns or less. In this case, since the length and width of each domain formed corresponding to each light-shielding section becomes 100 microns or less, the domain size can be reduced below the resolution of a human eye, making each domain invisible to the naked eye.

Here, while the first light irradiation was performed without using a light-shielding mask, and the second light irradiation was performed with a light-shielding mask, these orders may be reversed. In either case, there is an advantage in that multiple light-shielding masks are not used, thereby eliminating the need for highly accurate alignment between the light-shielding masks.

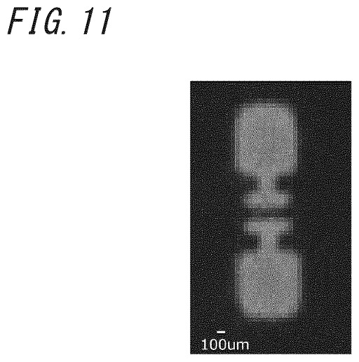

FIG. 11 is an enlarged view (photograph) of the boundary portion between the domains of the liquid crystal element manufactured by the manufacturing method of the fourth embodiment. Here, liquid crystal element 1 was manufactured by adding 0.5 wtc% of the RM agent shown in FIG. 5A to the liquid crystal material. The liquid crystal layer thickness was set to 4 μm, and a typical vertical alignment film was used as the alignment film. Tilt angle θ during the first and second light irradiation was set to 45°. The rotation angle in the azimuth angle direction was set to 90°. The ultraviolet light irradiation intensity for each irradiation was set to 10 mW/cm², the first light irradiation was performed for 2 minutes, and the second light irradiation was performed for 2 minutes. No voltage has been applied to liquid crystal layer 19.

As shown in the photograph, it can be seen that when a voltage is applied to liquid crystal layer 19, domains with different alignment directions (directors) are obtained. Further, in the domains shown relatively brightly in the photograph, the narrowest portion has a width and length of about 100 μm, and it can be seen that an extremely fine domain can be formed. Furthermore, the boundary between the domains is clearly defined, with no disclination lines or the like.

### Fifth Embodiment

After carrying out the light irradiation process shown in the third embodiment or the fourth embodiment described above, a third light irradiation can be carried out while applying a voltage to liquid crystal element 1 in the same manner as the second light irradiation according to the second embodiment. Specifically, two light irradiations are performed as described above with reference to FIG. 8A and FIG. 8B, or two light irradiations are performed as described with reference to FIG. 10A and FIG. 10B. As a result, a plurality of domains with different alignment directions are formed in liquid crystal layer 19. Thereafter, as described above with reference to FIG. 6B, while applying a voltage to liquid crystal layer 19, a third light irradiation is performed from the normal direction (tilt angle θ=0°) with reference to the substrate surface of liquid crystal element 1. This allows the pretilt angle in each domain to be controlled according to the magnitude of the applied voltage.

For example, when a liquid crystal element for high-duty driving application is desired, as one example, a high pretilt angle of about 89.0° can be imparted by setting the applied voltage to 2.5 V. On the other hand, when a liquid crystal element for low-duty driving application is desired, as one example, a low pretilt angle of about 85.0° to 88.0° can be imparted by setting the applied voltage to 4 to 6V.

### Sixth Embodiment

After carrying out the light irradiation process shown in the third embodiment or the fourth embodiment (refer to FIG. 8A, FIG. 8B, or FIG. 10A, FIG. 10B), a third and fourth light irradiation can be carried out while applying a voltage to liquid crystal element 1 in the same manner as the second light irradiation according to the second embodiment. Specifically, first, two light irradiations are performed as described above with reference to FIG. 8A and FIG. 8B, or two light irradiations are performed as described above with reference to FIG. 10A and FIG. 10B. As a result, a plurality of domains with different alignment directions are formed in liquid crystal layer 19.

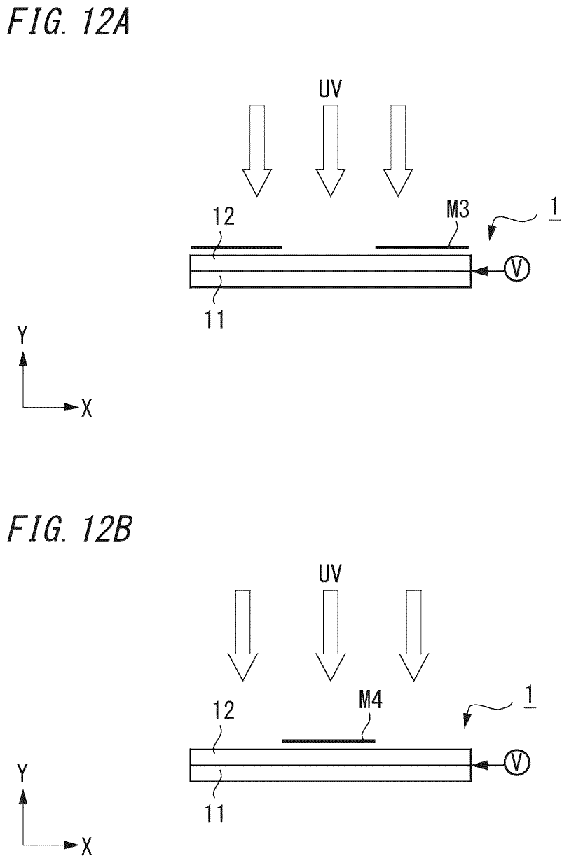

Then, while applying a voltage to liquid crystal layer 19, a third light irradiation and a fourth light irradiation are performed from the normal direction (tilt angle θ=0°) of the substrate surface of liquid crystal element 1. At this time, first, as shown in FIG. 12A, the third light irradiation is performed using a light-shielding mask M3 that covers a part of the substrate surface of liquid crystal element 1. That is, light irradiation is performed without light entering the part of liquid crystal layer 19. Next, as shown in FIG. 12B, the fourth light irradiation is performed using a light-shielding mask M4 that covers the other part of the substrate surface of liquid crystal element 1. That is, light irradiation is performed without light entering the other part of liquid crystal layer 19. At this time, different voltages are applied to liquid crystal layer 19 during the first voltage application (the third light irradiation) and the second voltage application (the fourth light irradiation). For example, voltage of the first voltage application can be 2.5V, and voltage of the second voltage application can be 4 to 6V. As a result, depending on the magnitude of the applied voltage, it is possible to control the pretilt angle to different values in the region not shielded by light-shielding mask M3 and the region not shielded by light-shielding mask M4.

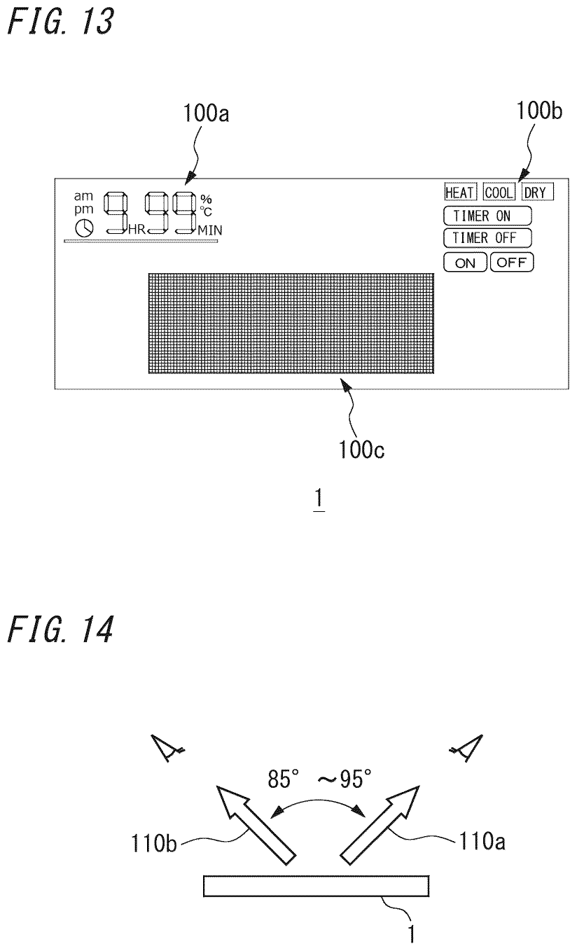

FIG. 13 is a schematic planer view illustrating a configuration example of a liquid crystal element manufactured by applying the manufacturing method according to the sixth embodiment. This liquid crystal element 1 has a region 100a for displaying a clock, a region 100b for displaying standard characters, and a region 100c having a plurality of pixels arranged in a matrix and capable of displaying arbitrary patterns.

Since regions 100a and 100b are regions where low-duty driving is desired, the above-described light-shielding mask M3 is configured to cover at least region 100c but not regions 100a and 100b. And, as an example, light irradiation is performed with an applied voltage to liquid crystal layer 19 set to 4 to 6V. As a result, a low pretilt angle of about 85.0° to 88.0° can be imparted to regions 100a and 100b of liquid crystal layer 19.

On the other hand, since region 100c is a region where high-duty driving is desired, the above-described light-shielding mask M4 is configured to cover at least regions 100a and 100b but not region 100c. And further, as an example, light irradiation is performed with an applied voltage to liquid crystal layer 19 set to 2.5V. As a result, a high pretilt angle of approximately 89.0° can be imparted to region 100c of liquid crystal layer 19.

### Seventh Embodiment

When light irradiation processes shown in the third embodiment or the fourth embodiment is carried out (refer to FIG. 8A, FIG. 8B or FIG. 10A FIG. 10B), the direction of irradiation for each light irradiation can also be set so that the angle between the director directions in each domain formed in the liquid crystal layer 19 by the first light irradiation and the domain formed in the liquid crystal layer 19 by the second light irradiation becomes approximately 90° (for example, 85° to 95°).

As a result, as liquid crystal element 1 shown in FIG. 14, a best viewing direction 110a for the domain corresponding to the first light irradiation and a best viewing direction 110b for the domain corresponding to the second light irradiation can be set in different directions. Such liquid crystal element 1 can be applied to an in-vehicle display apparatus. For example, by setting one best viewing direction 110a to face an occupant in a driver's seat and the other best viewing direction 110b to face another occupant in a passenger seat, an in-vehicle display apparatus that is easy to view for both occupants can be obtained.

### Eighth Embodiment

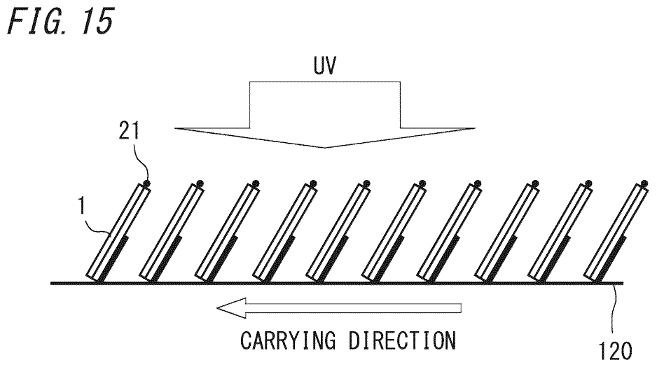

In each of the above-described embodiments, when irradiating liquid crystal elements 1 with light from a relative oblique angle relative to the substrate surface, it is also preferable to use a jig 120 capable of mounting a plurality of liquid crystal elements 1 at an angle, as illustrated in FIG. 15. Here, by use of a photocurable material (such as a photocurable resin) as an end seal material 21 which is provided to seal the injection port used to form liquid crystal layer 19, this end seal material 21 can be cured simultaneously. This further simplifies the manufacturing process.

### Polymer Layer Structure Common to all Embodiments

The inventors of the present application investigated the mechanism of the alignment regulating force exerted by the polymer layer obtained in each of the above embodiments as follows.

First, as a comparative experiment, a liquid crystal element was fabricated without adding an RM agent to liquid crystal layer 19. This liquid crystal element has the same configuration as liquid crystal element 1 shown in FIG. 1 described above, except for the lack of an RM agent. And a vertical alignment film is formed on each of first substrate 11 and second substrate 12. This liquid crystal element was irradiated with ultraviolet light for 4 hours and 30 minutes, with a tilt angle θ of the substrate surface set to 45°. Thereafter, a voltage was applied to the liquid crystal layer of the liquid crystal element. When alignment direction of the liquid crystal molecules was observed, slight anisotropy was observed, and in comparison to the liquid crystal elements of each of the embodiments, direction of azimuth angle was aligned differently by 90°, and uniformity of the alignment state was low. It is generally known that the side chains of an alignment film for an liquid crystal element are broken by prolonged exposure to ultraviolet light, and when polarized light is applied, the alignment may occur in a direction perpendicular to that of the light. Since the ultraviolet light irradiator is a reflective optical system, the irradiated light may contain a small amount of polarized component, which is considered to be the cause of this effect.

Next, using the same liquid crystal element as in the comparative experiment described above, ultraviolet light was irradiated for three hours while the liquid crystal element was rotated with the tilt angle θ maintained at 45°. The liquid crystal element was rotated in order to eliminate the effects of polarized light. Thereafter, a voltage was applied to the liquid crystal layer of the liquid crystal element. When the alignment direction of the liquid crystal molecules was observed, anisotropy was no longer observed, and the alignment direction of the liquid crystal molecules were aligned in random directions. This is considered to be due to the disappearance of the effects of polarization of the irradiated ultraviolet light, thereby eliminating anisotropy.

The conclusion based on these comparative experiments is that an alignment film alone does not uniformly align the liquid crystal layer. Here, when a liquid crystal element containing 0.5 wt % RM agent was irradiated with ultraviolet light for 10 minutes using the same ultraviolet light irradiation method, uniform uniaxial alignment was confirmed. Therefore, it is considered that alignment control is possible even with unpolarized ultraviolet light.

Next, a liquid crystal element was fabricated without vertical alignment films. This liquid crystal element has the same configuration as liquid crystal element 1 shown in FIG. 1 described above, except that it does not have vertical alignment films. Here, since no alignment films were formed, 2.5 wt % of a self-alignment agent was added to liquid crystal layer 19 in order to vertically align liquid crystal layer 19. A liquid crystal element with insulating films covering each pixel electrode 14 and common electrode 13, and a liquid crystal element without an insulating film were fabricated. And each liquid crystal element was irradiated with ultraviolet light for 10 minutes at a tilt angle θ of 45°. When alignment state of each liquid crystal element was observed, a uniform alignment state was obtained, similar to when vertical alignment films were formed. From the above results, it is considered that the polymer layer obtained by polymerizing the RM agent by light irradiation is what predominantly controls the alignment direction in liquid crystal layer 19.

Based on the results of the comparative experiments described above, the structure of the polymer layer in the liquid crystal element of each embodiment can be estimated and represented by the following model. Here, the description will be given using one of the pair of substrates in the liquid crystal element.

As shown in FIG. 16A, before the polymer layer is formed, a vertical alignment film is formed on one surface side of a substrate 200, with its side chains 201 rising up from one surface of substrate 200. When a liquid crystal material with an RM agent added is injected between the pair of substrates to form liquid crystal layer 19, as shown in FIG. 16B, monomers 202 gather on the one surface of substrate 200, in other words, near the interface between the liquid crystal layer and substrate 200. It is considered that each monomer 202 aligns in a substantially vertical direction along side chains 201 of the vertical alignment film. Here, “substantially vertical direction” refers to the direction normal to the one surface of substrate 200 or a direction close to it.

When a first light irradiation is performed to the liquid crystal element in this state, polymerization begins near the interface between substrate 200 and the liquid crystal layer, and as shown in FIG. 16C, polymers 203 are formed tilted in the direction along the light irradiation direction. These polymers 203 form a polymer layer, which is a polymerized film. It is considered that each polymer layer in liquid crystal element 1 of the first embodiment has this structure.

Next, when a second light irradiation is performed, polymers 204 arranged at an angle in the direction of the light irradiation are formed by piling up on polymers 203 formed by the first light irradiation. These polymers 204 form a polymer layer, which is a polymerized film.

Therefore, it is presumed that the alignment regulating force of polymers 203 due to the first light irradiation is weakened, and the alignment regulating force acts in a direction close to the alignment regulating force of polymers 204 due to the second light irradiation, causing the liquid crystal molecules in the liquid crystal layer to be influenced by polymers 204 and align along the long axis of polymers 204. This holds true even when light irradiation is repeated three or more times, and it is presumed that the polymerized film configured by the finally formed polymer exerts the strongest alignment regulating force. Here, when light irradiation is performed while partially shielding liquid crystal layer 19, such as in the third embodiment, the shielded portion becomes a polymer layer which includes the above-described polymers 203, and the un-shielded portion becomes a polymer layer which includes polymers 204, resulting in obtaining domains corresponding to the alignment of these polymers.

In a conventional method of imparting alignment regulating force by irradiating an alignment film with ultraviolet light or the like (so-called photo-alignment method), a side chain of the alignment film is generally cut by the light irradiation, and the remaining side chain is used to align the liquid crystal molecules. On the contrary, in the method of each of the embodiments, an alignment regulating force is generated in a direction roughly aligned with the direction of the light irradiation. As described above, it is considered that the molecular-level polymerized film extends in the direction along the light irradiation, overlapping not only in a planar manner but also in the direction toward the inside of the liquid crystal layer, resulting in polymerization.

### Relationship Between Light Irradiation Time and Easy Axis of Alignment

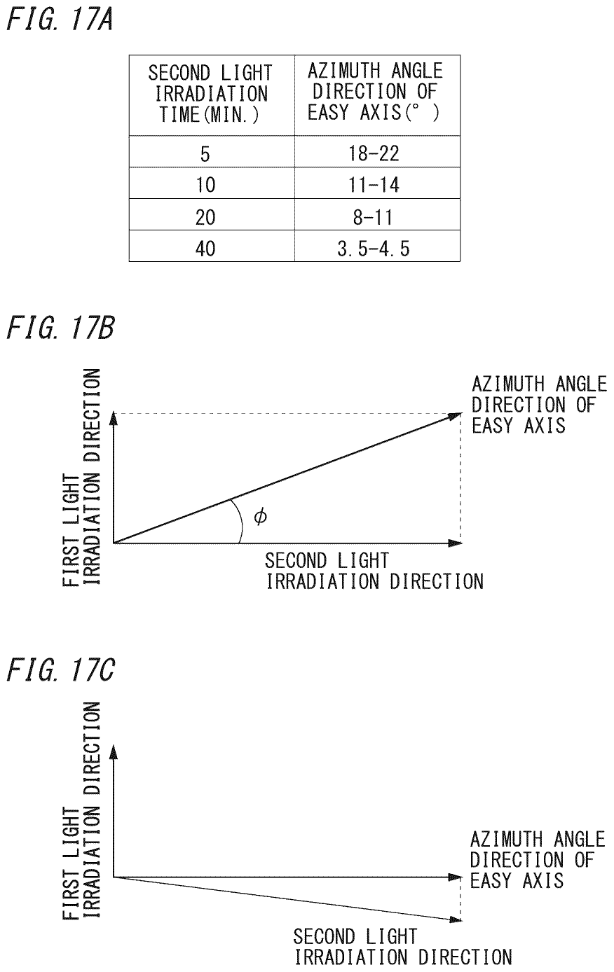

In the manufacturing method of the third embodiment described above, the first irradiation was performed with a tilt angle θ of 45° and the entire substrate surface of liquid crystal element 1 was irradiated with light for 5 minutes, and the second irradiation was performed with a tilt angle θ of 45° while light irradiation direction was rotated by 90° and irradiation time was variably set. For each of the liquid crystal elements obtained in this manner, FIG. 17A shows a measurement example in which the azimuth angle direction of the easy axis of the liquid crystal layer (easy axis of alignment) was determined. The “azimuth angle direction of the easy axis” as referred to here is the angle of deviation from the direction of light irradiation, as shown in FIG. 17B. As shown in FIG. 17A, it can be seen that the azimuth angle direction of the easy axis changes according to the second light irradiation time. Specifically, it can be seen that the longer the second light irradiation time, the closer the easy axis becomes to the direction of the second light irradiation. However, even when the second light irradiation time is extended, it can be said that it is difficult to exactly align the direction of second light irradiation and the easy axis. Therefore, in order to obtain two domains in the liquid crystal layer whose alignment directions are approximately perpendicular to each other, as illustrated in FIG. 17C, the direction of the second light irradiation needs to be set at an angle greater than the azimuth angle direction of the easy axis. In the liquid crystal element of the measurement example illustrated in FIG. 17A, when the second light irradiation time is set to 20 minutes, it is considered that when the second light irradiation direction is set to about 100° relative to the first light irradiation direction, the azimuth angle direction of the easy axis can be set at approximately 90°. When a liquid crystal element was actually fabricated under these conditions, two domain alignments with alignment directions that differed from each other by approximately 90° was obtained.

According to the above-described embodiments, it is possible to provide a technique for manufacturing a liquid crystal element that can realize alignment treatment of a liquid crystal layer through a simple process. Further, it is possible to provide a liquid crystal element obtained by the above process.

Here, note that the present disclosure is not limited to the content of the above-described embodiments, and can be variously modified and implemented within the scope of the gist of the present disclosure. For example, in each of the embodiments described above, alignment films have been used in the liquid crystal element, but these alignment films are not necessarily provided, and insulating films covering the pixel electrodes and the common electrode may be provided instead. Here, providing alignment films has the effect of stabilizing the alignment state of the liquid crystal layer over the long term.

The present application is based on, and claims priority from, JP Application Serial Number, 2025-018488 filed on Feb. 6, 2025, the disclosure of which is hereby incorporated by reference herein in its entirety.

### DESCRIPTION OF SYMBOLS

11: First substrate
12: Second substrate
13: Common electrode
14: Pixel electrode
15, 16: Alignment film
17, 18: Polymer layer (Polymerized film)
19: Liquid crystal layer
20: Sealing material
21: End seal material
200: Substrate
201: Side chain
202: Monomer
203, 204: Polymer

What is claimed is:

1. A manufacturing method of a liquid crystal element having a liquid crystal layer disposed between a pair of substrates, the method comprising:
(a) preparing a first substrate and a second substrate, each having a transparent electrode on its one surface side;
(b) forming a liquid crystal layer between one surface of the first substrate and one surface of the second substrates using a liquid crystal material containing a polymerizable molecule; and
(c) forming a polymer layer on the one surface side of each of the first substrate and the second substrate by performing light irradiation to the liquid crystal layer through the first substrate or the second substrate;
wherein the above description (c) includes performing a first light irradiation to the entire liquid crystal layer from a direction oblique with respect to an other surface that faces the one surface of the first substrate or the second substrate.

2. The manufacturing method of a liquid crystal element according to claim 1,
wherein, following the first light irradiation, the description (c) includes performing a second light irradiation to the entire liquid crystal layer from a normal direction of the other surface while applying a voltage to the liquid crystal layer.

3. The manufacturing method of a liquid crystal element according to claim 1,
wherein the description (c) includes performing the first light irradiation while no light is incident on a part of the liquid crystal layer, and performing the second light irradiation to the entire liquid crystal layer at a position where the other surface is rotated in the azimuth angle direction.

4. The manufacturing method of a liquid crystal element according to claim 1,
wherein the description (c) includes performing the first light irradiation to the entire liquid crystal layer, and performing the second light irradiation while no light is incident on a part of the liquid crystal layer at a position where the other surface is rotated in the azimuth angle direction.

5. The manufacturing method of a liquid crystal element according to claim 3,
wherein, following the first light irradiation and the second light irradiation, the description (c) includes performing a third light irradiation to the entire liquid crystal layer from a normal direction of the other surface while applying a voltage to the liquid crystal layer.

6. The manufacturing method of a liquid crystal element according to claim 1,
wherein the description (c) also serves to cure an end seal material for sealing an injection opening used when forming the liquid crystal layer.

7. The manufacturing method of a liquid crystal element according to claim 1,
wherein the polymerizable molecule has polymerizable groups located at its both ends and two or less ring structures.

8. A liquid crystal element comprising:
a first substrate and a second substrate arranged with one surface side of each substrate facing each other;
a liquid crystal layer arranged between one surface of the first substrate and one surface of the second substrates; and
a polymer layer arranged between the first substrate and the liquid crystal layer, and between the second substrate and the liquid crystal layer;
wherein the polymer layer contains a plurality of polymers having a major axis in a direction oblique to one surface of the first substrate and one surface of the second substrate; and
wherein, when a voltage is applied, the liquid crystal layer forms at least two domains configured corresponding to the direction of the major axis of each of the plurality of polymers contained in the polymer layer.

9. The liquid crystal element according to claim 8,
wherein the absolute value of the angle between director directions of the two domains is between 85° and 95°.

10. The liquid crystal element according to claim 8,
wherein the two domains each has a different pretilt angle.

11. The liquid crystal element according to claim 8,
wherein each of the two domains has a different size in a planer view.

12. The manufacturing method of a liquid crystal element according to claim 4,
wherein, following the first light irradiation and the second light irradiation, the description (c) includes performing a third light irradiation to the entire liquid crystal layer from a normal direction of the other surface while applying a voltage to the liquid crystal layer.
